(19) United States
(12) Patent Application Publication
(10) Pub. No.: US 2002/0144864 A1
(43) Pub. Date: Oct. 10, 2002

(54) Multi-point lubrication distribution system

(76) Inventor: Siegfried Kramer, Sebring, OH (US)

Correspondence Address: R.C. Harpman, 819 Southwestern Run, Youngstown, OH, 44514, US

(21) Appl. No.: 10/108,850

(22) Filed: Mar. 27, 2002

(30) Foreign Application Priority Data
Apr. 4, 2001 (DE) 201 05 885.5

(51) Int. Cl. F16N 13/20

(52) U.S. Cl. 184/35

(57) ABSTRACT

A sequential programmable lubrication dispenser system using a remote multiple ported rotary distributor in communication with a number of independent lubrication points. The multi-point distributor is supplied lubricant under pressure by an independent remote lubrication pump. Both lubrication pump and the rotary distributor have independent motorized activation that are sequentially linked by a programmable central controller. Rotary distributor has an apertured distributor disk that rotatably engages each of the multiple discharge ports allowing pressurized lubricant to flow out to multiple lubrication points at the pre-selected times.

This patent claims foreign priority based on German Gebrauchsmusters No. 201 05 885.5, filed Apr. 4, 2001.

### BACKGROUND OF THE INVENTION

1. Technical Field

This invention relates to lubrication of industrial machines which require multiple lubrication points on a reoccurring schedule to assure proper operation and reduce wear between critical moving parts such as bearings and joints.

2. Description of Prior Art

Prior art devices that have been developed for the reoccurring lubrication of multiple lubrication points have been directed to point of use self-contained systems that are installed at each lubrication point. Such automatic systems typically have a self-contained lubricant drive means and some have a sequential timer that can be preset to activate and apply lubricant in a periodic manner, see for example U.S. Pat. Nos. 5,271,528, 5,386,883, 5,409,084, 5,634,531 and 5,971,229.

U.S. Pat. Nos. 5,386,883 and 5,409,084 use a gas generating cartridge to supply pressure to a piston that delivers lubricant to a lubrication point.

U.S. Pat. Nos. 5,271,528, 5,634,531 and 5,971,229 utilize an electric motor that advances a distributor piston within a pre-filled reservoir of lubricant which is then metered out to lubrication points.

A number of prior art devices utilize multi-point distribution of lubricant using a variety of mechanical activation systems and sequential point selection, see for example U.S. Pat. Nos. 768,529, 791,418,1,862,164, 1,886,067, 3,217,835, 4,286,691, 4,632,448, 4,944,367 and 5,181,585 which are incorporated by reference herein.

Applicant's own pending application Ser. No. 09/747,140, filed Dec. 22, 2000 is directed to a self-contained multi-port lubrication dispenser having a multiple port rotary distributor with a motor driven piston that pressurize a lubricant reservoir and a rotating distributor manifold that successively registers with each of the multiple discharge ports. The motor has an on-board timer and self-contained power supply for periodic activation in selectable timing sequences.

Applicant's German Gebravuchsmusters No. 201 05 885.5, filed Apr. 4, 2001 which is directed to a device for distribution of lubricant having multi-port distribution housing with a distributor disk that is selectively rotated by a motor allowing lubricant to be distributed through aligned portals. Lubricant is supplied to the distributor housing by an integral pressurized lubrication reservoir.

### SUMMARY OF THE INVENTION

A multi-point programmable lubrication system for use in lubricating remote lubrication points on machines and the like. The lubrication system utilizes programmable interlinked independent multiple lubricant distributors having multiple outlet ports in communication with multiple lubrication points. A central lubrication reservoir and pump supplies lubricant under pressure to remote distribution distributors. Both the lubrication pump and distributor are controlled from a central programmable controller having co-dependent interval and cyclability.

### DESCRIPTION OF THE DRAWINGS

FIG. 1 is a graphic side elevational view of the lubrication pump and distributor of the invention;

FIG. 2 is a partial cross-sectional view of the lubrication pump;

FIG. 3 is a top plan cross-sectional view of the cam activated pump portion of the lubrication pump on lines 3-3 of FIG. 1;

FIG. 4 is an enlarged partial cross-sectional view of the distributor of the invention;

FIG. 5 is an enlarged top plan view of the indexing outlet portals with portions broken away; and

FIG. 6 is a schematic block flow diagram of the control circuit associated with the lubrication system.

### DESCRIPTION OF THE PREFERRED EMBODIMENT

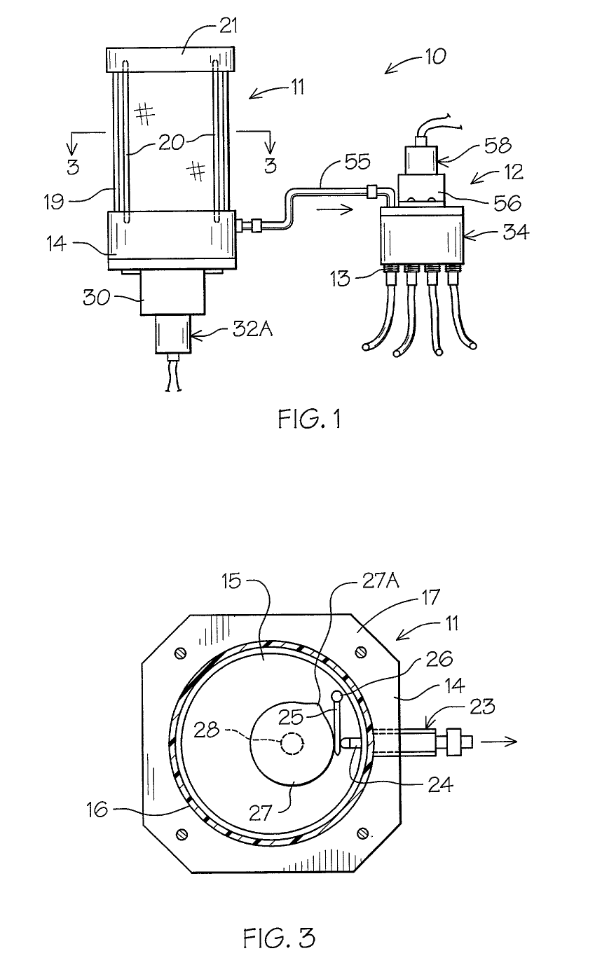

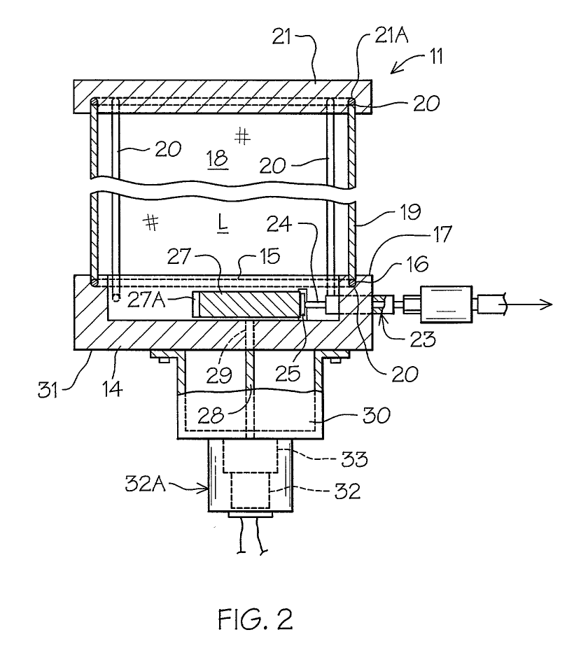

Referring to FIG. 1 of the drawings, a multi-point lubrication system 10 can be seen having a central lubrication reservoir and a pump assembly 11 and a motorized multiple distributor assembly 12. The multiple point distributor assembly 12 is adapted to receive a plurality of outlet fittings 13, each of which connect with a lubrication point of a machine to be lubricated (not shown). The lubrication reservoir and pump assembly 11 has a base 14 with a central recessed portion 15 therein. An annular channel 16 extends about the recessed portion 15 within a top engagement surface 17 of the base 13. A lubricant reservoir 18 is formed by a storage cylinder 19 and recessed portion 15 which is sealingly positioned within the channel 16 by a gasket-sealing element 20 within. An annular closure 21 having a corresponding annular channel 21A and an internal sealing gasket 20 is engageable on the free end of the cylinder 19. A plurality of locking rods 22 are threadably engaged between the base 14 and the closure 21 securing the cylinder 19 therebetween in a sealing relationship therewith, as best seen in FIG. 2 of the drawings. The base 14 has a fluid pump 23 threadably secured within. The fluid pump 23 is well known within the art as a piston pump which are commercially available, an example of which is manufactured by Vogel AG of Berlin, Germany.

As noted, such fluid pumps 23 of this type utilize a reciprocating spring urged piston and one-way ball valves and so well understood by those skilled in the art that further explanation or illustration is not required.

The pump 23 has a reciprocating plunger pin 24 extending therefrom within the recess portion 15 of the lubrication reservoir 18 as best seen in FIGS. 2 and 3 of the drawings. An activation arm 25 pivotally extends from a support post 26 for engagement with the plunger pin 24 as will be hereinafter described.

An activation cam 27 has a cammed surface 27A that is positioned within the recessed portion 15 so as to be selectively engageable with the activation arm 25 during cam rotation. The cam 27 has an integral drive shaft 28 extending therefrom through a sealing aperture 29 in the base 13.

A motor mounting bracket 30 is secured to and extends from the bottom surface 31 of the base 14. A drive motor 32 and interconnected gear box 33 are positioned on the mounting bracket 30 being interconnected to the cam drive shaft 28.

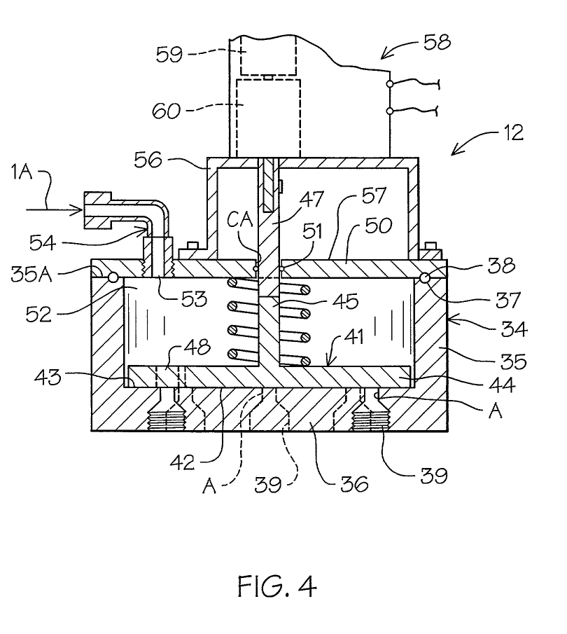

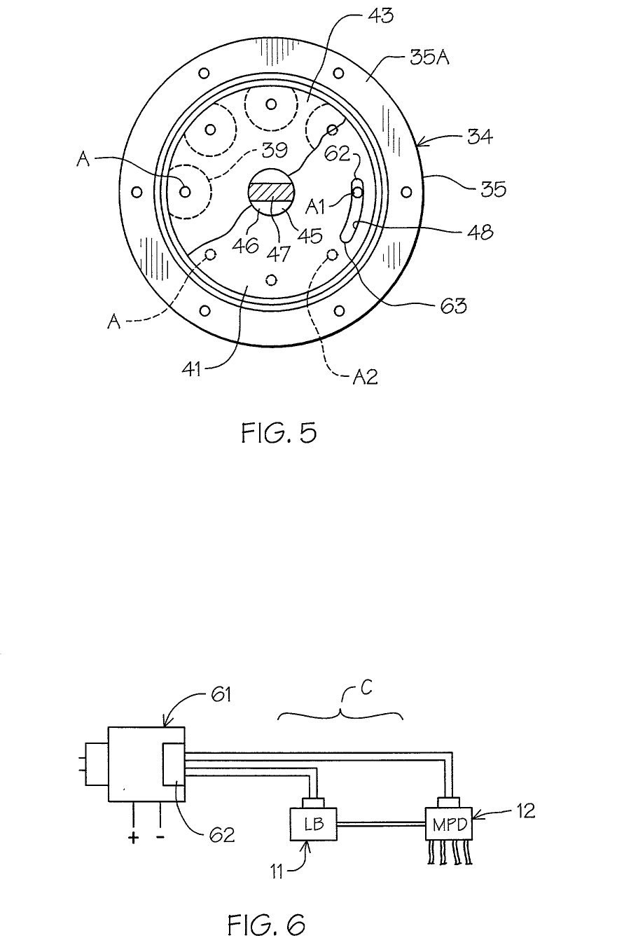

Referring now to FIGS. 4 and 5 of the drawings, the multi-port distribution assembly 12 can be seen having an annular housing 34 with a contoured sidewall 35 and integral bottom 36. The sidewall 35 has an annular O-ring seat 37 in its upper surface 35A and corresponding O-ring 38 within. The bottom 36 has a plurality of annularly spaced apertures A within. Each of the apertures A has an enlarged internally threaded manifold outlet 39. Each manifold outlet 39 is adapted to receive the fitting 13 by which a line 40 extends and is in communication with a prescribed lubrication point (not shown) is to be lubricated by the multi-point distributor 11.

A distributor disk 41 is positioned within the housing 34 so that the disks lower face 42 seats upon the bottom 36 lower face 43. The distributor disk 41 comprises a circular plate 44 with an integral drive stem 45 extending axially therefrom. The drive stem 45 has a registration slot 46 within its end for inner engagement with a drive spindle 47. The distributor disk 41 has a contoured opening at 48 within its circular plate 44. It will be evident that as the disk 41 rotates, the contoured opening 48 will selectively register with each of the apertures A successively as best seen in FIG. 5 of the drawings. A spring 49 is positioned on the drive stem 45 so as to apply constant pressure to the disk 41 against the bottom lower face 43.

A cap plate 50 is secured to the top surface 35A of the wall 35 and has a particular opening CA within through which the drive spindle 47 extends. Seating rings 51 are provided about the drive spindle 47 to maintain a seal and thus define a pressurized distribution chamber 52 within the housing 34.

A lubricant inflow inlet 53 and associated interconnected fittings 54 are within the cap plate 50 and is interconnected to the lubrication pump 11 by a conduit 55 indicated by the inflow arrow IA and illustrated in FIG. 1 of the drawings.

A motor mount 56 is secured to and extends from the upper surface 57 of the cap plate 50. An electrical drive unit 58 illustrated graphically is positioned on the motor mount 56. The electrical drive unit 58 comprises an electric motor 59 and a gear reduction assembly 60 for driving the drive spindle 47.

Referring now to FIG. 6 of the drawings, a central control unit 61 is interconnected with the respective motor assemblies 32A and 58 defining a control circuit C operating same. The controller 61 includes a programmable time circuit 62 operable to periodically activate the respective motor assemblies 32A and 58 causing the cam 27 and pump 11 to rotate engaging the pivot arm 25 and corresponding pump pin 24 pumping lubricant L from within the lubrication reservoir 18 to the distributor 12 maintaining lubricant pressure within the chamber 15. Simultaneously, the motor 59 engages the drive spindle 47 via the gear box 60 and interconnected disk spindle 45 with the distributor disk 41. Lubricant L under pressure is displaced through the respective aperture ports A as the contoured opening 48 and the disk 44 successfully registers with each of the apertures A as hereinbefore described. The lubricant flows through the fittings 40 into the lubrication transport lines attached thereto and out to the respective remote lubrication points (not shown). It will be seen that as the contoured opening 48 will be registered fully with only one aperture A at a time, it is also noted that the leading edge 63 of an opening A1 may begin to register with adjacent opening A2 before the trailing edge 64 of the aperture has completed its registration with the previous opening A1 as seen in broken lines in FIG. 5 of the drawings. This will keep delivery pressure of the lubricant L from pulsating during lubrication operation.

The controller 61 can be programmed to provide a variety of different operational lubricant criteria in which both the lubrication interval defined as the time between cycles i.e. daily, monthly, etc. are available as well as the cycle time i.e. the actual duration of the lubrication transfer thus the amount can be selectively determined and programmed accordingly.

It will be evident to those skilled in the art that relative size and spacing of the openings A, A1 and A2 and the relative size of the contoured opening 48 will determine the amount i.e. duration of lubricant to a corresponding remote lubrication point. By being programmable, the controller 61 can provide any lube cycle required to match the machine and its user environment.

It is often advantageous to have many short lubrication cycles for a lubrication point rather than a few longer lubrication cycles thus reducing required maintenance and increase the useful life of the machine.

It will thus be seen that a new and useful multi-point lubrication distribution system has been illustrated and described and it will be apparent to those skilled in the art that various changes and modifications may be made therein without departing from the spirit of the invention.

Therefore I claim:

1. A multi-point lubrication dispensing system for providing lubricant to a number of remote lubrication points, the lubricant dispensing system comprises, a motorized lubrication pump, a motorized lubrication distributor and a programmable controller with a control circuit, said lubrication distributor having a distribution disk within, a distribution chamber for containing a lubricant, the distribution disk has a contoured opening within, a drive stem extending axially from said distribution disk, a plurality of spaced outlets within said chamber lined for selective sequential registration with said contoured opening in said disk, said lubrication pump comprising an electric motor and a storage reservoir for lubricant and a pump element, means for reciprocation of said pump element within said reservoir, means for interconnecting said pump element to said distribution chamber under lubricant pressure, means for maintaining sealing contact between said distribution disk face and said chamber face.

2. The multi-point lubrication distribution system set forth in claim 1 wherein said motorized lubrication distributor further comprises, an electric drive unit, said electric drive unit having an electric motor, a drive and power source interconnected to said motor and a shaft extending from selective drive unit.

3. The multi-point lubrication dispenser system set forth in claim 2 wherein said lubrication distributor has a control circuit and wherein said control circuit is in electrical communication with said electric motor and said controller.

4. The multi-port lubrication dispensing system set forth in claim 3 wherein said controller includes a timing circuit operable to periodically activate said electric motor to rotate said distributor disk.

5. The multi-port lubrication dispensing system set forth in claim 1 wherein said distribution chamber has a distributor plate secured thereto with a lubricant inflow port and an actual aperture within through which said drive stem of said distribution disk extends.

6. The multi-port lubrication distribution set forth in claim 1 wherein said outlets in said distribution chamber define a manifold wherein said outlets are in communication with said inlet lubrication points.

7. The multi-port lubrication distribution set forth in claim 1 wherein said means for containing rotatably sealing contact between said disk face and said chamber face comprises a spring about said disk stem.

8. The multi-port lubrication dispensing system set forth in claim 2 wherein said distribution disk stem has a distal end engageable with a drive shaft of said electrical drive unit.

9. The multi-port lubrication distribution system set forth in claim 1 wherein said means for reciprocation of said pump element within said respective reservoir comprises a rotating cam and a selectively engageable engagement arm, said cam in communication with said electric motor of said electric drive unit.

10. The multi-port lubrication dispensing system set forth in claim 1 wherein said means for interconnecting said pump element to said distribution chamber comprises, a pressurized conduit.

11. A multi-port lubrication dispensing system for lubricating a plurality of lubrication points, said lubrication dispenser comprises a motorized lubrication pump having an electric drive unit, a pump element and a reservoir containing a lubricant,
a multi-point rotary distribution having a manifold chamber having a manifold face and a number of outlets within, a distributor disk having a central stem extending therefrom for engagement with said manifold, said disk having a contoured opening within, a cap plate secured to said manifold defining a distribution chamber, said manifold having a manifold face and a number of outlets for sequential alignment with said contoured opening in said distributor disk, a controller electrically connected to said respective lubrication pump electrical drive unit and said rotating distributor electrical drive unit.

12. The multi-point lubrication dispenser system set forth in claim 11 wherein said lubrication pump is in communication with said rotating distributor disk wherein said first electrical drive unit rotates a cam so as to advance the cam selectively against a pivoted cam engagement arm to reciprocate said pump element to displace a portion of lubricant from the reservoir to said inlet in said cap plate of said rotary distributor.

13. The multi-port lubrication dispensing system set forth in claim 12 wherein said electrical drive units comprise an electric motor and a gear reduction unit interconnected thereto.

14. The multi-point lubrication dispenser system set forth in claim 11 wherein said controller comprises an electric control circuit, a programmable CPU within said control circuit and means for programming said CPU to determine activation of said respective lubrication pump electrical drive unit and said rotary distributor electrical drive unit for cycling an interval of lubrication dispenser to said multiple lubrication points.
